(19) United States
(12) Patent Application Publication
(10) Pub. No.: US 2024/0317966 A1
(43) Pub. Date: Sep. 26, 2024

(54) RUBBER COMPOSITION, AND RUBBER PRODUCT AND HOSE EACH OBTAINED USING SAID RUBBER COMPOSITION

(71) Applicant: Sumitomo Riko Company Limited, Aichi (JP)

(72) Inventors: Mayuka Taira, Aichi (JP); Takaki Nakashima, Aichi (JP); Ryo Hirai, Aichi (JP)

(73) Assignee: Sumitomo Riko Company Limited, Aichi (JP)

(21) Appl. No.: 18/735,214

(22) Filed: Jun. 6, 2024

Related U.S. Application Data
(63) Continuation of application No. PCT/JP2023/010636, filed on Mar. 17, 2023.

(30) Foreign Application Priority Data
Mar. 30, 2022 (JP) 2022-055698

(51) Int. Cl. C08K 5/11; C08K 3/04; C08K 7/00

(52) U.S. Cl. CPC C08K 5/11; C08K 3/04; C08K 7/00

(57) ABSTRACT

A rubber composition contains components (A) to (D) described below: (A) a rubber-based polymer; (B) a plant-derived filler; (C) carbon black; and (D) diacetyl monododecanoyl glyceride.

### CROSS-REFERENCE TO RELATED APPLICATION

This application is a continuation of PCT International Application No. PCT/JP2023/010636, filed on Mar. 17, 2023, which claims priority under 35 U.S.C § 119(a) to Japanese Patent Application No. 2022-055698, filed on Mar. 30, 2022. Each of the above application(s) is hereby expressly incorporated by reference, in its entirety, into the present application.

### BACKGROUND

### Technical Field

The present disclosure relates to a rubber composition, as well as a rubber product and a hose each obtained using the rubber composition. In detail, the present disclosure relates to a rubber composition adopting non-petroleum-derived raw materials in order to achieve carbon neutrality, as well as relates to a rubber product and a hose each obtained using the rubber composition.

### Related Art

Carbon black or the like, which is derived from petroleum, has conventionally been used as a general reinforcing material for rubber products (for example, see Japanese Patent Laid-open No. 2017-15123).

Under such circumstances, in response to the recent global movement toward carbon neutrality, there have been discussions about reducing the proportion of petroleum-derived raw materials and adopting non-petroleum-derived raw materials in rubber products.

As part of this, for example, there have been discussions about using a plant-derived filler such as cellulose fibers as a filler for rubber products (for example, see Japanese Patent Laid-open No. 2020-055951).

However, plant-derived fillers generally have more polar groups (hydroxyl groups) on their surfaces than carbon black, and thus are less likely to be dispersed in rubber. Due to this, elongation properties of rubber products are significantly inhibited. Hence, in the case where plant-derived fillers are used, the properties required for rubber products may be less likely to be exhibited.

In the case of only reducing the proportion of petroleum-derived raw materials, reinforcement properties, vulcanization shrinkage properties or the like of rubber products may be adversely affected.

### SUMMARY

One aspect of the present disclosure provides a rubber composition containing components (A) to (D) described below:
(A) a rubber-based polymer;
(B) a plant-derived filler;
(C) carbon black; and
(D) diacetyl monododecanoyl glyceride.

Other aspects of the present disclosure provide a rubber product and a hose each obtained using the rubber composition described above.

### DESCRIPTION OF THE EMBODIMENTS

The present disclosure provides a rubber composition by which it is possible to reduce the proportion of petroleum-derived raw materials without impairing the properties such as elongation properties required for a rubber product. The present disclosure also provides a rubber product and a hose each obtained using the rubber composition.

The present inventors have considered preparing a rubber composition in the following manner. That is, a rubber-based polymer (A) is used in combination with a plant-derived filler (B) and carbon black (C). Furthermore, diacetyl monododecanoyl glyceride (D) being a plant-derived plasticizer that facilitates dispersion of the plant-derived filler (B) or the carbon black (C) in the rubber-based polymer (A) is added. By doing so, it has been found that dispersibility of the plant-derived filler (B) or the carbon black (C) can be increased, and deterioration of elongation properties can be reduced. Furthermore, it has been found that the proportion of petroleum-derived raw materials can be reduced by the use of the plant-derived filler (B) or the diacetyl monododecanoyl glyceride (D).

On the other hand, the present disclosure is summarized as [1] to [7] below.

[1] A rubber composition contains components (A) to (D) described below:
(A) a rubber-based polymer;
(B) a plant-derived filler;
(C) carbon black; and
(D) diacetyl monododecanoyl glyceride.

[2] In the rubber composition described in [1], the component (C) is carbon black having a DBP oil absorption of 60 to 200 cm³/100 g.

[3] In the rubber composition described in [1] or [2], the component (A) is a rubber-based polymer having a polar group.

[4] In the rubber composition described in any one of [1] to [3], the component (A) is at least one selected from a group consisting of acrylic rubber, acrylonitrile-butadiene rubber, chloroprene rubber, chlorosulfonated polyethylene rubber, epichlorohydrin homopolymer, epichlorohydrin-ethylene oxide binary copolymer, epichlorohydrin-allyl glycidyl ether binary copolymer, epichlorohydrin-ethylene oxide-allyl glycidyl ether terpolymer, and a blend polymer of acrylonitrile-butadiene rubber and polyvinyl chloride.

[5] In the rubber composition described in any one of [1] to [4], the component (B) is at least one selected from a group consisting of granules of cellulose, lignin, or biomass plastic, granules obtained by crushing a seed shell, and granules obtained by crushing a fruit core.

[6] A rubber product is obtained by crosslinking the rubber composition described in any one of [1] to [5].

[7] A hose includes a single layer or a plurality of layers, in which the hose includes a layer including a crosslinked body of the rubber composition described in any one of [1] to [5].

From the above, according to the rubber composition as well as the rubber product and the hose each obtained using the rubber composition of the present disclosure, the proportion of petroleum-derived raw materials can be reduced without impairing the properties such as elongation properties required for a rubber product.

Next, an embodiment of the present disclosure will be described in detail. However, the present disclosure is not limited to this embodiment.

In the present disclosure, unless otherwise specified, an expression “X to Y” (X and Y are arbitrary numbers) means “equal to or greater than X and equal to or less than Y,” and also means “preferably greater than X” or “preferably less than Y.”

An expression “equal to or greater than X” (X is an arbitrary number) or “equal to or less than Y” (Y is an arbitrary number) also means “preferably greater than X” or “preferably less than Y.”

An expression “X and/or Y” (X and Y are arbitrary configurations) means at least one of X and Y, and has three meanings: only X, only Y, and X and Y.

A rubber composition (hereinafter referred to as “the present rubber composition”) of the present disclosure contains components (A) to (D) described below:
(A) a rubber-based polymer;
(B) a plant-derived filler;
(C) carbon black; and
(D) diacetyl monododecanoyl glyceride.

Each of the above components is described in detail below.

### [Rubber-Based Polymer (A)]

The rubber-based polymer (A) used in the present rubber composition is not particularly limited, and a rubber-based polymer having a polar group is preferably used because of good compatibility with a plant-derived filler.

Specific examples of the rubber-based polymer having a polar group include acrylic rubber, acrylonitrile-butadiene rubber (NBR), chloroprene rubber, chlorosulfonated polyethylene rubber, epichlorohydrin rubber (epichlorohydrin homopolymer (CO), epichlorohydrin-ethylene oxide binary copolymer (ECO), epichlorohydrin-allyl glycidyl ether binary copolymer (GCO), epichlorohydrin-ethylene oxide-allyl glycidyl ether terpolymer (GECO)), and a blend polymer of acrylonitrile-butadiene rubber and polyvinyl chloride (NBR-PVC). The foregoing may be used singly or in combination of two or more. Among them, epichlorohydrin rubber and acrylonitrile-butadiene rubber are preferably used because of excellent compatibility with a plant-derived filler.

In view of excellent dispersibility of the plant-derived filler (B) or the carbon black (C), the rubber-based polymer has an SP value in the range of preferably 8.5 to 10.5, more preferably 9 to 10.

Here, the SP value is also called a solubility parameter, is an index indicating the polarity of a substance, and can be determined by the following equation (1).

$$S P = \sqrt{Δ E / V} \qquad ( 1 )$$

In the above equation (1), ΔE represents evaporation energy, and V represents molar volume.

### [Plant-Derived Filler (B)]

Examples of the plant-derived filler (B) include granules of cellulose, lignin, or biomass plastic such as polylactic acid, granules obtained by crushing a seed shell, and granules obtained by crushing a fruit core. The foregoing may be used singly or in combination of two or more. Among them, cellulose and lignin are preferably used because of ease of procurement.

Examples of a plant material as the basis of the plant-derived filler (B) include: wood (such as that of a conifer such as Japanese red pine, Japanese black pine, Saghalien fir, Ezo pine, Siberian pine, larch, fir, southern Japanese hemlock, Japanese cedar, hinoki, shirabe, Japanese spruce, cypress, Douglas fir, hemlock, white fir, spruce, balsam fir, cedar, pine, Merkus pine, or radiata pine; and that of a broad-leaved tree such as beech, birch, alder, oak, Japanese bay tree, chinquapin, white birch, cottonwood, poplar, Japanese ash, Japanese poplar, eucalyptus, mangrove, lauan, or acacia); bamboo; sugarcane; seed hair fiber [such as cotton fiber (cotton linter), or kapok]; ginskin fiber (such as hemp, paper mulberry, or paper bush); leaf fiber (such as Manila hemp, sisal hemp, New Zealand hemp, or luobuma); fruit fiber (coconut); rush; and wheat straw.

In the case where the plant-derived filler (B) is cellulose fiber or cellulose nanofiber, an average fiber length thereof is preferably 50 μm to 500 μm, more preferably 50 μm to 200 μm. By such setting, excellent reinforcement properties, dispersibility, elongation properties, or the like may be achieved.

The average fiber length is obtained by measuring the fiber lengths of about 120 fibers using a transmission electron microscope (TEM) or a scanning electron microscope (SEM), and calculating the average thereof.

Commercially available examples of the plant-derived filler (B) include “Fibra-Cel” (product name) manufactured by Celite, “nanoforest” (product name) manufactured by Chuetsu Pulp & Paper, “BiNFi-s” (product name) manufactured by Sugino Machine, “Cellenpia” (product name) manufactured by Nippon Paper Industries, “Celish” (product name) manufactured by Daicel Finechem, “Fluorene Cellulose” (product name) manufactured by Osaka Gas Chemicals, “KC Flock” (product name) manufactured by Nippon Paper Industries, “Ceolus” (product name) manufactured by Asahi Kasei, “Tosco Hemp Cellulose Powder,” “Tosco Silk Powder,” and “Bamboo Powder” (all product names) manufactured by Tosco, and “Cellulose Powder” (product name) manufactured by TDI.

A content ratio of the plant-derived filler (B) in the present rubber composition is in the range of preferably 10 to 80 parts by mass, more preferably 20 to 60 parts by mass, even more preferably 20 to 40 parts by mass, with respect to 100 parts by mass of the rubber-based polymer (A). The reason is that, if the amount of the plant-derived filler (B) is excessively small, reinforcement properties, vulcanization shrinkage properties or the like tend to be adversely affected; if the amount of the plant-derived filler (B) is excessively large, elongation of rubber tends to deteriorate.

### [Carbon Black (C)]

Examples of the carbon black (C) include grades such as SAF grade, ISAF grade, HAF grade, MAF grade, MAF-HS grade, FEF grade, GPF grade, SRF grade, SRF-HS grade, FT grade, and MT grade. The foregoing may be used singly or in combination of two or more. Among them, SRF-HS grade carbon black is preferably used because of excellent reinforcement properties.

From the viewpoint of reinforcement properties, the carbon black (C) has a DBP oil absorption in the range of preferably 60 to 200 cm³/100 g, more preferably 90 to 200 cm³/100 g, and even more preferably 110 to 200 cm³/100 g.

The DBP oil absorption of the carbon black (C) is a value obtained by expressing a structure of carbon black in terms of the amount (cm³/100 g) of dibutyl phthalate (DBP) absorbed per 100 g of carbon black. The DBP oil absorption is a value measured in accordance with JIS K 6217-4.

A content ratio of the carbon black (C) in the present rubber composition is in the range of preferably 5 to 80 parts by mass, more preferably 10 to 60 parts by mass, even more preferably 15 to 40 parts by mass, with respect to 100 parts by mass of the rubber-based polymer (A). The reason is that, if the amount of the carbon black (C) is excessively small, strength or the like of the rubber composition tends to deteriorate; if the amount of the carbon black (C) is excessively large, the result is undesirable in view of the spirit of the present disclosure, that is, to reduce the proportion of petroleum-derived raw materials.

### [Diacetyl Monododecanoyl Glyceride (D)]

A content ratio of the diacetyl monododecanoyl glyceride (D) in the present rubber composition is in the range of preferably 5 to 60 parts by mass, more preferably 10 to 40 parts by mass, even more preferably 15 to 30 parts by mass, with respect to 100 parts by mass of the rubber-based polymer (A). The reason is that, if the amount of the diacetyl monododecanoyl glyceride (D) is excessively small, there is a risk that a sufficient effect of dispersing the plant-derived filler (B) or the carbon black (C) may not be achieved, and it may become difficult to reduce deterioration of elongation properties of rubber; if the amount of the diacetyl monododecanoyl glyceride (D) is excessively large, there is a risk that rubber molding processability may be adversely affected.

### [Other Materials]

In addition to the rubber-based polymer (A), the plant-derived filler (B), the carbon black (C), and the diacetyl monododecanoyl glyceride (D), a vulcanizing agent, a vulcanization aid, a vulcanization accelerator, a processing aid, a filling material (excluding plant-derived filler (B) and carbon black (C)), an anti-aging agent, and a retarder are appropriately blended in the present rubber composition. If crosslinking is performed using an organic peroxide, a co-crosslinking agent may be used in combination in order to increase crosslinking efficiency and improve physical properties.

Examples of the vulcanizing agent include: a triazine compound, such as 1,3,5-triazine and 2,4,6-trimercapto-s-triazine; an imidazole compound, such as 1-methylimidazole, 1,2-dimethylimidazole, 1-benzyl-2-methylimidazole, and 1-cyanoethyl-2-methylimidazole; hexamethylene diamine; hexamethylene diamine carbamate; tetramethylene pentamine; hexamethylene diamine-cinnamaldehyde adduct; ammonium benzoate; hexamethylene diamine dibenzoate salt; 4,4′-methylene dianiline; 4,4′-oxyphenyldiphenylamine; m-phenylenediamine; p-phenylenediamine; and 4,4′-methylenebis(o-chloroaniline). The foregoing may be used singly or in combination of two or more.

In the case where the rubber-based polymer (A) is a diene rubber such as NBR, sulfur, for example, may be used as the vulcanizing agent.

The content of the vulcanizing agent is usually set in the range of 0.5 to 3 parts by mass, preferably in the range of 1 to 2 parts by mass, with respect to 100 parts by mass of the rubber-based polymer (A).

### <Vulcanization Aid>

Examples of the vulcanization aid include zinc oxide, active zinc white, and magnesium oxide, and they may be used singly or in combination of two or more.

The content of the vulcanization aid is usually set in the range of 0.5 to 5 parts by mass, preferably in the range of 2 to 4 parts by mass, with respect to 100 parts by mass of the rubber-based polymer (A).

### <Vulcanization Accelerator>

Examples of the vulcanization accelerator include trimethylthiourea, stearyltrimethylammonium bromide, and di-o-tolylguanidine. The foregoing may be used singly or in combination of two or more.

The content of the vulcanization accelerator is usually set in the range of 0.5 to 5 parts by mass, preferably in the range of 1 to 3 parts by mass, with respect to 100 parts by mass of the rubber-based polymer (A).

### <Processing Aid>

Examples of the processing aid include stearic acid, n-octadecylamine, polyoxyethylene stearyl ether phosphate, and glycerin fatty acid ester. The foregoing may be used singly or in combination of two or more.

The content of the processing aid is usually set in the range of 0.5 to 5 parts by mass, preferably in the range of 1 to 3 parts by mass, with respect to 100 parts by mass of the rubber-based polymer (A).

### <Filling Material>

Examples of the filling material other than the plant-derived filler (B) and the carbon black (C) include silica, calcium carbonate, titanium oxide, talc, clay, and glass balloon. The foregoing may be used singly or in combination of two or more.

The content of the filling material is usually set in the range of 3 to 70 parts by mass, preferably in the range of 5 to 40 parts by mass, with respect to 100 parts by mass of the rubber-based polymer (A).

### <Anti-Aging Agent>

Examples of the anti-aging agent include 4,4′-(α,α-dimethylbenzyl)diphenylamine, and nickel dibutyldithiocarbamate. The foregoing may be used singly or in combination of two or more.

The content of the anti-aging agent is usually set in the range of 0.5 to 5 parts by mass, preferably in the range of 1 to 2 parts by mass, with respect to 100 parts by mass of the rubber-based polymer (A).

### <Retarder>

Examples of the retarder include phthalic anhydride, benzoic acid, salicylic acid, N-nitrosodiphenylamine, N,N′,N″-tris(isopropylthio)-N,N′,N″-triphenylphosphoric triamide, N-cyclohexylthiophthalimide, and N-(trichloromethylthio)benzenesulfonamide. The foregoing may be used singly or in combination of two or more.

The content of the retarder is usually set in the range of 0.1 to 3 parts by mass, preferably in the range of 0.5 to 1.5 parts by mass, with respect to 100 parts by mass of the rubber-based polymer (A).

### <Organic Peroxide>

Examples of the organic peroxide include: peroxy ketals, such as 1,1-bis(t-butylperoxy)-3,3,5-trimethylcyclohexane, 1,1-bis(t-hexylperoxy)-3,3,5-trimethylcyclohexane, 1,1-bis(t-hexylperoxy)cyclohexane, 1,1-bis(t-butylperoxy)cyclododecane, 1,1-bis(t-butylperoxy)cyclohexane, 2,2-bis(t-butylperoxy)octane, n-butyl-4,4-bis(t-butylperoxy)butane, and n-butyl-4,4-bis(t-butylperoxy)valerate; dialkyl peroxides, such as di-t-butyl peroxide, dicumyl peroxide, t-butylcumyl peroxide, α,α′-bis(t-butylperoxy-m-isopropyl)benzene, α,α′-bis(t-butylperoxy)diisopropylbenzene, 2,5-dimethyl-2,5-di(t-butylperoxy)hexane, and 2,5-dimethyl-2,5-bis(t-butylperoxy)hexyne-3; diacyl peroxides, such as acetyl peroxide, isobutyryl peroxide, octanoyl peroxide, decanoyl peroxide, lauroyl peroxide, 3,5,5-trimethylhexanoyl peroxide, benzoyl peroxide, 2,4-dichlorobenzoyl peroxide, and m-trioyl peroxide; peroxyesters, such as t-butylperoxyacetate, t-butylperoxyisobutyrate, t-butylperoxy-2-ethylhexanoate, t-butylperoxylaurylate, t-butylperoxybenzoate, di-t-butylperoxy isophthalate, 2,5-dimethyl-2,5-di(benzoylperoxy)hexane, t-butylperoxymaleic acid, t-butylperoxyisopropyl carbonate, and cumyl peroxyoctate; and hydroperoxides, such as t-butyl hydroperoxide, cumene hydroperoxide, diisopropylbenzene hydroperoxide, 2,5-dimethylhexane-2,5-dihydroperoxide, and 1,1,3,3-tetramethylbutyl peroxide. The foregoing may be used singly or in combination of two or more.

The content of the organic peroxide is usually set in the range of 0.1 to 5 parts by mass, preferably in the range of 0.3 to 2 parts by mass, with respect to 100 parts by mass of the rubber-based polymer (A).

### <Co-Crosslinking Agent>

Examples of the co-crosslinking agent include a sulfur-containing compound, a polyfunctional monomer, a maleimide compound, and a quinone compound. The foregoing may be used singly or in combination of two or more.

Examples of the sulfur-containing compound include sulfur, dipentamethylenethiuram tetrasulfide, and mercaptobenzothiazole. Examples of the polyfunctional monomer include divinylbenzene, ethylene glycol dimethacrylate, diallyl phthalate, trimethylolpropane trimethacrylate, triallyl cyanurate, triallyl isocyanurate (TAIC), triallyl trimellitate, and triallyl tricyanurate. Examples of the maleimide compound include N,N′-m-phenylene bismaleimide and toluylene bismaleimide. Examples of the quinone compound include quinone dioxime and dibenzoyl-p-quinone dioxime.

The content of the co-crosslinking agent is usually set in the range of 0.1 to 5 parts by mass, preferably in the range of 0.3 to 2 parts by mass, with respect to 100 parts by mass of the rubber-based polymer (A).

The present rubber composition can be prepared, for example, in the following manner. That is, the rubber-based polymer (A), the plant-derived filler (B), the carbon black (C), and the diacetyl monododecanoyl glyceride (D) are blended together. The other components are further blended therein as necessary. The thus obtained mixture is kneaded using a kneading machine such as a roll, a kneader, or a Banbury mixer.

By crosslinking the present rubber composition into a predetermined shape using a mold or the like as necessary, a desired rubber product can be manufactured. In the thus obtained rubber product (hereinafter referred to as “the present rubber product”) of the present disclosure, the proportion of petroleum-derived raw materials can be reduced without impairing the properties such as elongation properties required for the rubber product.

Examples of the present rubber product include a hose, a packing, an oil seal, a roll for OA equipment, and anti-vibration rubber.

Here, as an example of a method for manufacturing the present rubber product, a method for manufacturing a hose is shown below.

That is, first, after a rubber composition is prepared as described above, the rubber composition is extrusion-molded into a tubular (cylindrical) shape to form an uncrosslinked rubber layer. In the case of manufacturing a hose having a multilayer structure, layers made of various rubbers or resins are formed on an outer periphery of the rubber layer (innermost layer) by extrusion molding or the like. In the case of forming a reinforcing yarn layer, a reinforcing yarn is subjected to braid knitting or the like at a predetermined doubling count and a predetermined pick and end count, and the reinforcing yarn layer is formed on the outer periphery of the rubber layer (innermost layer). A mandrel is inserted into the thus obtained uncrosslinked hose structure. A mold release agent such as a silicone oil may be applied to a surface of the mandrel as necessary. As described above, instead of inserting the mandrel into the uncrosslinked hose structure (uncrosslinked rubber hose), the rubber composition may be directly extrusion-molded onto the mandrel. The uncrosslinked rubber hose extrusion-molded onto the mandrel in this manner is subjected to crosslinking using pressurized steam, followed by removal of the mandrel, and is subjected to secondary crosslinking in an oven as necessary. Thereby, a desired hose can be fabricated.

The thus obtained hose (hereinafter referred to as “the present hose”) of the present disclosure may have a single layer structure, or a multilayer structure in which two or more layers are laminated.

An overall thickness of the present hose is preferably 0.25 mm to 20 mm, more preferably 0.5 mm to 10 mm. An inner diameter of the hose is preferably 2 mm to 100 mm, more preferably 5 mm to 70 mm.

Although not particularly limited, the present hose is preferably used in applications where it is required to reduce the proportion of petroleum-derived raw materials without impairing elongation properties or the like. For example, the present hose can be used as a hose such as a fuel hose, air hose, or oil hose for automobiles.

### EXAMPLES

Next, examples will be described together with comparative examples. However, the present disclosure is not limited to these examples.

First, prior to the examples and comparative examples, the materials shown below were prepared.

### [ECO]

Epichlorohydrin rubber (Hydrin T3105B, manufactured by Zeon Corporation)

### [NBR]

Acrylonitrile-butadiene rubber (Nipol DN101, manufactured by Zeon Corporation)

### [Cellulose Fiber]

KC Flock W-400G, manufactured by Nippon Paper Industries

[Carbon Black (i)]

SRF-HS grade carbon black (having a DBP oil absorption of 125 cm³/100 g) (SPHERON 5200, manufactured by Cabot Japan)

[Carbon Black (ii)]

SRF grade carbon black (having a DBP oil absorption of 68 cm³/100 g) (SEAST S, manufactured by Tokai Carbon)

[Carbon Black (iii)]

MAF-HS grade carbon black (having a DBP oil absorption of 158 cm³/100 g) (SEAST G-116HM, manufactured by Tokai Carbon)

[Plasticizer (i)]

Diacetyl monododecanoyl glyceride (BIOCIZER, manufactured by Riken Vitamin)

[Plasticizer (ii)]

Polyether ester-based plasticizer (ADK CIZER RS-966, manufactured by ADEKA)

### Example 1

100 parts by mass of ECO, 30 parts by mass of cellulose fiber, 15 parts by mass of carbon black (i), 15 parts by mass of plasticizer (i), 2 parts by mass of stearic acid (Beads Stearic Acid Sakura, manufactured by NOF Corporation), 3 parts by mass of magnesium oxide (Kyowamag 150, manufactured by Kyowa Chemical Industry), 1 part by mass of an anti-aging agent (Nocrac NBC, manufactured by Ouchi Shinko Chemical Industrial), 1.5 parts by mass of a processing aid (Rikemal XO-100, manufactured by Riken Vitamin), 1 part by mass of a retarder (Retarder CTP, manufactured by Toray Industries) and 1.5 parts by mass of 2,4,6-trimercapto-s-triazine (ZISNET F, manufactured by Sankyo Kasei) were blended, kneaded using a 5 L kneader, followed by being transferred to an open roll for continuing kneading, thereby preparing a rubber composition.

### Examples 2 and 3 and Comparative Examples 1 to 3

A rubber composition was prepared in accordance with Example 1, except that the types and blending amounts of each material (shown in Table 1 described later) in Example 1 were changed as shown in Table 1.

### Example 4

100 parts by mass of NBR, 30 parts by mass of cellulose fiber, 15 parts by mass of carbon black (i), 15 parts by mass of plasticizer (i), 2 parts by mass of stearic acid (Beads Stearic Acid Sakura, manufactured by NOF Corporation), 3 parts by mass of magnesium oxide (Kyowamag 150, manufactured by Kyowa Chemical Industry), 1 part by mass of an anti-aging agent (Nocrac NBC, manufactured by Ouchi Shinko Chemical Industrial), 1.5 parts by mass of a processing aid (Rikemal XO-100, manufactured by Riken Vitamin), 1 part by mass of a retarder (Retarder CTP, manufactured by Toray Industries) and 1 part by mass of sulfur (manufactured by Tsurumi Chemical Industry) were blended, kneaded using a 5 L kneader, followed by being transferred to an open roll for continuing kneading, thereby preparing a rubber composition.

Each property was evaluated in accordance with the following criteria using the thus obtained rubber compositions of Examples and Comparative Examples. These results are also shown in Table 1 described later.

### <Elongation/strength Physical Properties>

The rubber composition was press-molded using a press vulcanizer so as to have a shape of a 2 mm thick rubber sheet for measuring tensile properties, and a vulcanized rubber sheet was fabricated. Next, with respect to a sample obtained from the vulcanized rubber sheet, tensile strength TS (MPa) and elongation EB (%) were measured in accordance with JIS K 6251-2017 (Rubber, vulcanized or thermoplastic-Determination of tensile stress-strain properties). Tensile strength TS and elongation EB were evaluated in accordance with the following criteria.
⊚ (excellent): tensile strength TS was 9.0 MPa or more and elongation EB was 350% or more
◯ (very good): tensile strength TS was 5.0 MPa or more and elongation EB was 200% or more
x (poor): tensile strength TS was less than 5.0 MPa and/or elongation EB was less than 200%

### [Carbon Neutrality]

A ratio of biomass-derived materials used in the rubber composition with respect to the entire rubber composition was calculated, and carbon neutrality was evaluated in accordance with the following criteria.
⊚ (excellent): the ratio of biomass-derived materials was 50% by mass or more
◯ (very good): the ratio of biomass-derived materials was 20% by mass or more and less than 50% by mass
x (poor): the ratio of biomass-derived materials was less than 20% by mass

### [Vulcanization Shrinkage Properties]

The rubber composition was hollow extrusion-molded into a tubular (cylindrical) shape with an inner diameter of 30 mm and a wall thickness of 4 mm, and then cut into a length of 300 mm. The thus obtained unvulcanized rubber hose was pressure vulcanized with steam at 160° C. for 20 minutes to obtain a rubber hose. A vulcanization shrinkage rate of the rubber hose was determined by the following equation, and was evaluated in accordance with the following criteria.

$$Vulcanization shrinkage rate ( \% ) = \text{} [ ( length of unvulcanized rubber hose - length of rubber hose after vulcanization ) / length of unvulcanized rubber hose ] \times 100$$

⊚ (excellent): shrinkage rate was less than 2%
◯ (very good): shrinkage rate was 2% or more and less than 8%
x (poor): shrinkage rate was 8% or more

TABLE 1
(Part by mass)

| | Example | | | | Comparative Example | | |
|---|---|---|---|---|---|---|---|
| | 1 | 2 | 3 | 4 | 1 | 2 | 3 |
| ECO | 100 | 100 | 100 | — | 100 | 100 | 100 |
| NBR | — | — | — | 100 | — | — | — |
| Cellulose fiber | 30 | 30 | 30 | 30 | — | 30 | 30 |
| Carbon black (i) | 15 | — | — | 15 | 45 | 15 | 15 |
| Carbon black (ii) | — | 15 | — | — | — | — | — |
| Carbon black (iii) | — | — | 15 | — | — | — | — |
| Plasticizer (i) | 15 | 15 | 15 | 15 | 15 | — | — |
| Plasticizer (ii) | — | — | — | — | — | — | 15 |
| Elongation/strength physical properties | ⊚ | ◯ | ⊚ | ⊚ | ⊚ | X | X |
| Carbon neutrality | ⊚ | ⊚ | ⊚ | ◯ | X | ◯ | ◯ |
| Vulcanization shrinkage properties | ⊚ | ◯ | ⊚ | ⊚ | X | ◯ | ⊚ |

According to the results shown in Table 1, all of the rubber compositions of Examples exhibited excellent elongation/strength physical properties, satisfied carbon neutrality, and exhibited excellent vulcanization shrinkage properties.

In contrast, the rubber composition of Comparative Example 1 contained no cellulose fibers, and exhibited poor carbon neutrality and vulcanization shrinkage properties as a result. In the rubber composition of Comparative Example 2, cellulose fibers and carbon black were used in combination as in Examples. However, the rubber composition of Comparative Example 2 contained no diacetyl monododecanoyl glyceride, resulting in poor elongation/strength physical properties. In the rubber composition of Comparative Example 3, cellulose fibers and carbon black were also used in combination as in Examples. However, the rubber composition of Comparative Example 3 used a polyether ester plasticizer other than diacetyl monododecanoyl glyceride, and no improvement in elongation/strength physical properties was observed.

Although the examples described above have shown specific embodiments of the present disclosure, the examples are merely illustrative and should not be construed as limiting. Various modifications apparent to those skilled in the art are intended to be within the scope of the disclosure.

The present rubber composition may be used as a material of various rubber products such as hoses, packing, oil seals, rolls for office automation (OA) equipment, and anti-vibration rubber. The present rubber composition is preferably used as a material for forming a hose such as a fuel hose, air hose, or oil hose for automobiles. These hoses are preferably used in a transportation machine such as an automobile, a tractor, a cultivator, or a ship.

What is claimed is:

1. A rubber composition, containing components (A) to (D) described below:
(A) a rubber-based polymer;
(B) a plant-derived filler;
(C) carbon black; and
(D) diacetyl monododecanoyl glyceride.

2. The rubber composition according to claim 1, wherein
the component (C) is carbon black having a DBP oil absorption of 60 to 200 cm³/100 g.

3. The rubber composition according to claim 1, wherein
the component (A) is a rubber-based polymer having a polar group.

4. The rubber composition according to claim 1, wherein
the component (A) is at least one selected from a group consisting of acrylic rubber, acrylonitrile-butadiene rubber, chloroprene rubber, chlorosulfonated polyethylene rubber, epichlorohydrin homopolymer, epichlorohydrin-ethylene oxide binary copolymer, epichlorohydrin-allyl glycidyl ether binary copolymer, epichlorohydrin-ethylene oxide-allyl glycidyl ether terpolymer, and a blend polymer of acrylonitrile-butadiene rubber and polyvinyl chloride.

5. The rubber composition according to claim 1, wherein
the component (B) is at least one selected from a group consisting of granules of cellulose, lignin, or biomass plastic, granules obtained by crushing a seed shell, and granules obtained by crushing a fruit core.

6. A rubber product, obtained by crosslinking the rubber composition according to claim 1.

7. A hose, comprising at least one layer, wherein
the hose comprises a layer comprising a crosslinked body of the rubber composition according to claim 1.
